(19) United States
(12) Patent Application Publication
(10) Pub. No.: US 2024/0387884 A1
(43) Pub. Date: Nov. 21, 2024

(54) BROMINE SEQUESTRATION IN A BATTERY

(71) Applicant: Jonathan Faix, Othello, WA (US)

(72) Inventor: Jonathan Faix, Othello, WA (US)

(21) Appl. No.: 18/199,954

(22) Filed: May 21, 2023

(51) Int. Cl. H01M 10/42; H01M 4/62; H01M 10/36

(52) U.S. Cl. CPC H01M 10/4235; H01M 4/625; H01M 10/365; H01M 2300/0085

(57) ABSTRACT

This present patent application discloses is a battery with improved bromide sequestration wherein the battery includes parts such as an anode, which comprised of an electrically conductive material; a cathode that comprised of an electrically conductive carbon-based material; an electrolyte and a liquid used for bromine sequestration. The bromine sequestration liquid is nonpolar, immiscible, or virtually immiscible in water or aqueous-based gel and has a density greater than that of water. The bromine sequestration agent is selected from tetrabromoethane, tetrachloroethylene, carbon tetrachloride, tetrachloroethane, trichloroethane, tribromoethane, or a combination thereof. However, tetrabromoethane or tetrachloroethylene are preferred.

### CROSS-REFERENCE TO RELATED APPLICATION

Not applicable

### TECHNICAL FIELD OF THE INVENTION

The present invention generally relates to bromide sequestration and, more particularly, but not exclusively to bromide sequestration in a battery using a halogenated solvent. Accordingly, the present specification makes a specific reference to a battery. However, it is to be appreciated that aspects of the present invention are also equally amenable to other systems or environments where bromide sequestration is required.

### BACKGROUND

Bromide sequestration in a battery refers to the process of removing or isolating bromide ions from the electrolyte of a battery. This is important because bromide ions can react with the cathode or anode of the battery, leading to degradation of the battery's performance and reduced lifespan. Also, when bromine is used as the active species in a battery, it can escape from the electrode and diffuse through the electrolyte, causing the battery to lose efficiency and capacity.

One common method for bromide sequestration in batteries is to use an ion exchange resin. This involves introducing an ion exchange resin into the electrolyte solution, which selectively removes bromide ions and replaces them with other ions, such as chloride ions. The resin can then be removed from the solution and regenerated for reuse.

Another method for bromide sequestration in batteries is to use a membrane filtration system. This involves passing the electrolyte solution through a membrane that can selectively filter out bromide ions while allowing other ions to pass through. The filtered electrolyte can then be returned to the battery for continued use.

Yet another method for bromide sequestration in batteries is complexing bromide with amines or quaternary ammonium compounds to sequester the bromine. This process is also known as bromine quenching. By adding amines or quaternary ammonium compounds to the solution, the bromide ions can be sequestered and prevented from reacting with other compounds.

Amines and quaternary ammonium compounds have a positive charge and can interact with the negatively charged bromide ions through electrostatic interactions. The resulting complex is stable and non-reactive, effectively sequestering the bromide ions.

Yet another method for bromide sequestration in batteries is using flow batteries which pump bromine into storage tanks during charging and later pump it back into the reaction area during discharge. Flow batteries are a type of rechargeable battery that stores energy in liquid electrolyte solutions contained in tanks or reservoirs. It is possible that some flow battery systems could potentially be designed to remove or sequester bromide ions from a solution, depending on the specific electrolyte chemistry and system design. For example, if the electrolyte solution contains bromide ions, a flow battery system could potentially be designed to remove these ions from the solution during the charging or discharging process.

It is important to carefully consider the potential environmental and safety implications of the bromide sequestration method used in a battery, as well as its impact on the performance and lifespan of the battery. Additionally, the cost and feasibility of the method should be considered in the design and operation of the battery system.

While the methods of bromide sequestration in batteries, such as ion exchange resins, membrane filtration, complexing bromide with amines or quaternary ammonium compounds, and use of flow batteries can be effective in removing bromide ions from the electrolyte solution, they do have some drawbacks.

One of the main drawbacks of ion exchange resins is that they may not be able to completely remove all bromide ions from the electrolyte solution. This can lead to the accumulation of bromide ions over time, which can cause degradation of the battery's performance and reduce its lifespan. Additionally, the use of ion exchange resins can be expensive and may require frequent regeneration or replacement, which can add to the cost of the battery system.

Another drawback of membrane filtration is that it can be subject to fouling, which can reduce the effectiveness of the membrane in removing bromide ions. This can require more frequent maintenance and cleaning of the membrane, which can add to the operational cost of the battery system. Additionally, the use of membrane filtration can also be relatively expensive, especially for larger battery systems.

While complexing bromide with amines or quaternary ammonium compounds can be an effective method for bromide sequestration in batteries, it also has some drawbacks and limitations. One potential drawback is that the process of complexation can be reversible, which means that the bromide ions can potentially be released back into the solution under certain conditions, such as changes in temperature or pH. This could lead to recontamination of the electrolyte solution and potential performance issues.

Another limitation is that the use of amines or quaternary ammonium compounds can potentially introduce other contaminants or impurities into the electrolyte solution, which could also impact battery performance or longevity. In addition, the cost and availability of the required chemicals can be a significant factor, particularly for large-scale applications.

While complexing bromide with amines or quaternary ammonium compounds can be an effective approach for bromide sequestration in batteries, it is important to carefully consider the specific chemistry and system design to ensure that it is appropriate and effective for the intended application.

Bromide sequestration in batteries by using flow batteries, would likely require specialized system design, and would not be a common application of flow batteries making it not a good option.

In general, the drawbacks of these methods will depend on the specific application and the characteristics of the battery system, such as the size and capacity of the battery, the type of electrolyte solution used, and the level of bromide ion contamination in the electrolyte. It is important to find a simple and effective bromide sequestration method for a battery system.

Therefore, there is a need for a simple and effective bromide sequestration method for a battery system. There is also a need for generating an improved method for the sequestration of bromine and increasing the energy density of zinc-bromine batteries.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The present invention, in one exemplary embodiment, is a battery with improved bromine sequestration, comprising an anode comprised of an electrically conductive material; a cathode comprised of an electrically conductive carbon-based material; an electrolyte; and a liquid used for sequestration.

In a preferred embodiment, the cathode is in contact with, or partially immersed in the liquid used for sequestration and the electrolyte. The cathode comprises an insulated portion and an uninsulated portion wherein, the insulated portion of the cathode is electrically insulated from the electrolyte except at a reaction interface with the sequestration medium and the uninsulated portion of the cathode does not extend more than 2 cm out of the sequestration agent. The cathode material can be selected from carbon felt, carbon fiber, carbon foam, expanded graphite, aerogel carbon, xerogel carbon, sol-gelated carbon, activated carbon, charcoal, or any other electrically conductive carbon material. The cathode material further comprises an electrically insulated metal wire (such as Tantalum) in conjunction with the selected cathode material to create an electrically conductive circuit.

The anode composed of an electrically conductive material such as zinc or any other material that is conductive and resistant to bromine in an aqueous environment at ambient temperatures such as tantalum, carbon fiber, carbon felt, noble metals, titanium or possibly vanadium, etc

The electrolyte comprises of zinc bromide and water and can be an aqueous based gel. The bromine sequestration agent is liquid at ambient temperatures, nonpolar, immiscible, or virtually immiscible in water or aqueous-based gel, and has a density greater than that of water. The bromine sequestration agent is selected from tetrabromoethane, tetrachloroethylene, carbon tetrachloride, tetrachloroethane, trichloroethane, tribromoethane, or a combination thereof. However, tetrabromoethane or tetrachloroethylene are preferred.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front planar view of a battery of the present invention, in accordance with the disclosed architecture.

FIG. 2 illustrates a front planar view of an alternate battery arrangement of the present invention, in accordance with the disclosed architecture.

### DETAILED DESCRIPTION

The innovation is now described with reference to the embodiments and drawings. In the following description, for purposes of explanation, numerous specific details are set forth in order to provide a thorough understanding thereof. It may be evident, however, that innovation can be practiced without these specific details. In other instances, well-known processes and devices are shown in diagram form in order to facilitate a description thereof.

As noted above, there is a need for a simple and effective bromide sequestration method for a battery system. There is also a need for generating an improved method for the sequestration of bromine and increasing the energy density of zinc bromine batteries. The present invention, in one preferred embodiment, is a battery with improved bromine sequestration, comprising an anode comprised of an electrically conductive material; a cathode comprised of an electrically conductive carbon-based material; an electrolyte; and a liquid used for sequestration.

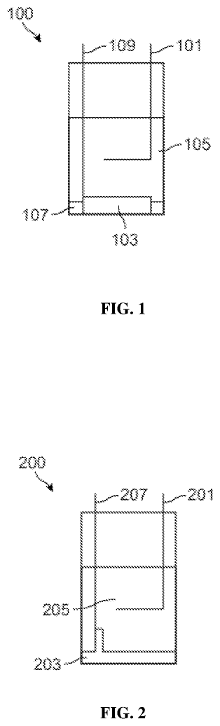

Referring initially to the drawings, FIG. 1 illustrates a front planar view of a battery 100 of the present invention, in accordance with the disclosed architecture. More specifically, the present invention, in one exemplary embodiment, is a battery 100 preferably a zinc-bromine battery with improved bromine sequestration, with different parts such as an anode 101 which is comprised of an electrically conductive material; a cathode 103 comprised of an electrically conductive carbon-based material; an electrolyte 105; and a liquid used for sequestration 107. The cathode 103 is an electrode through which electrons flow out of the battery 100. It is the electrode that is connected to the negative terminal of a voltage source, such as the battery 100. In a simple circuit, cathode 103 is the electrode connected to the ground or negative terminal, while anode 101 is the electrode connected to the positive terminal.

In a preferred embodiment, the cathode 103 is in contact with, or partially immersed in the liquid used for sequestration 107 and the electrolyte 105. The cathode 103 comprises an insulated portion and an uninsulated portion wherein, the insulated portion of the cathode 103 is electrically insulated from the electrolyte 105 except at a reaction interface with the sequestration medium 107, and the uninsulated portion of the cathode 103 does not extend more than 2 cm out of the sequestration agent 107. The materials used for electrical insulation have to be resistant to bromine, which is very corrosive. Such materials primarily include fluoropolymers such as PVDF or teflon (PTFE) and/or fluoroelastomers (rubber) such as Viton. Some plastics such as polyethylene can resist bromine in an aqueous environment, but will degrade when exposed to dry bromine. Glass is resistant to bromine and can be used as an insulation material. Any other metal can also be used if it is resistant to bromine.

The cathode material can be selected from carbon felt, carbon fiber, carbon foam, expanded graphite, aerogel carbon, xerogel carbon, sol-gelated carbon, activated carbon, charcoal, or any other electrically conductive carbon material. The cathode material further comprises an electrically insulated metal wire (such as Tantalum) in conjunction with the selected cathode material to create an electrically conductive circuit. Cathode 103 can be a combination of different carbon materials, such as a carbon fiber attached to carbon felt or inserted into a bed of activated carbon on the bottom of the vessel.

In an embodiment, the anode 101 is composed of an electrically conductive material such as zinc or any other material that is conductive and resistant to bromine in an aqueous environment at ambient temperatures such as tantalum, carbon fiber, carbon felt, noble metals, titanium, or possibly vanadium, etc

The electrolyte 105 comprises of zinc bromide and water and can be an aqueous-based gel. The bromine sequestration agent 107 is liquid at ambient temperatures, nonpolar, immiscible or virtually immiscible in water or aqueous-based gel, and has a density greater than that of water. The bromine sequestration agent 107 is selected from tetrabromoethane, tetrachloroethylene, carbon tetrachloride, tetrachloroethane, trichloroethane, tribromoethane, or a combination thereof. However, tetrabromoethane or tetrachloroethylene are preferred.

An advantage of the present invention is to provide an efficient and improved battery 100. The addition of a halogenated solvent 107 to electrolyte 105 can help to sequester the bromine and prevent it from diffusing through the cell. The halogenated solvent 107 reacts with the bromine to form a complex, which is less mobile and less likely to escape from the electrode. During the charging, the zinc in the electrolyte 105 is plated onto the anode 101 and the bromine is dissolved into the sequestration medium 107 at the site of the cathode 103. During the discharge the bromine, dissolved in the sequestration medium 107, is released and reacts with the zinc plated onto the anode 101 generating an electric current. Hence making the overall battery performance more efficient.

It is to be noted that solvents such as carbon tetrabromide or tetrabromoethylene, even though they are solids up to 95 Celsius and 50 Celsius respectively, bromine might still be absorbed into the materials. Hence these solvents are preferred to be used as bromine sequestering mediums.

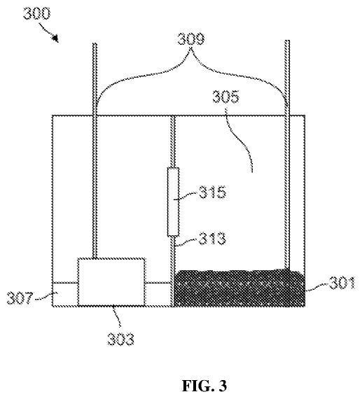

FIG. 2 illustrates a front planar view of an alternate battery 200 of the present invention, in accordance with the disclosed architecture. The alternate battery 200 also comprises an anode 201, a cathode comprising of the carbon fiber in contact with activated carbon mixed with halogenated solvent 203, an electrolyte 205, and a conductive wire 207. More such alternative arrangements are possible in such batteries.

As described throughout this application the terms “sequestering medium” “sequestering agent”, and “halogenated solvent”, will have a similar meanings throughout the invention. The battery of the present invention can be installed in any device which can be charged and discharged through normal electrochemical processes. Finally, the battery 100 of the present invention is relatively more efficient, inexpensive, safe, and easy to install and use.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A battery, comprising;
(a) an anode comprised of an electrically conductive material;
(b) a cathode comprised of an electrically conductive carbon-based material;
(c) an electrolyte; and
(d) a liquid used for sequestration;
wherein, the cathode is in contact with, or partially immersed in the liquid used for sequestration and the electrolyte.

2. The battery as claimed in claim 1, wherein the cathode comprises an insulated portion and an uninsulated portion.

3. The battery as claimed in claim 2, wherein the insulated portion of the cathode is electrically insulated from the electrolyte except at a reaction interface with the sequestration medium.

4. The battery as claimed in claim 2, wherein the uninsulated portion of the cathode does not extend more than 2 cm out of the sequestration agent.

5. The battery as claimed in claim 1, wherein the cathode material comprises carbon felt or carbon fiber or carbon foam or expanded graphite or aerogel carbon or xerogel carbon or sol-gelated carbon or activated carbon or charcoal or any other electrically conductive carbon material.

6. The battery as claimed in claim 1, wherein the cathode material further comprises an electrically insulated metal wire in conjunction with the selected cathode material to create an electrically conductive circuit.

7. The battery as claimed in claim 6, wherein, the electrically insulated metal is Tantalum.

8. The battery as claimed in claim 1, wherein the battery is a zinc bromine battery.

9. The battery as claimed in claim 1, wherein the electrolyte comprises of zinc bromide and water.

10. The battery as claimed in claim 1, wherein the electrolyte is aqueous based gel.

11. The battery as claimed in claim 1, wherein the bromine sequestration agent is liquid at ambient temperatures.

12. The battery as claimed in claim 1, wherein the bromine sequestration agent is nonpolar at ambient temperatures.

13. The battery as claimed in claim 1, wherein the bromine sequestration agent is immiscible or virtually immiscible in water or aqueous-based gel at ambient temperatures.

14. The battery as claimed in claim 1, wherein the bromine sequestration agent has a density greater than that of water at ambient temperatures.

15. The battery as claimed in claim 1, wherein the bromine sequestration agent is tetrabromoethane or tetrachloroethylene or carbon tetrachloride or tetrachloroethane or trichloroethane or tribromoethane or a combination thereof.

16. The battery as claimed in claim 15, wherein the bromine sequestration agent is tetrabromoethane.

17. The battery as claimed in claim 15, wherein the bromine sequestration agent is tetrachloroethylene.
